(19) United States
(12) Patent Application Publication
(10) Pub. No.: US 2015/0284044 A1
(43) Pub. Date: Oct. 8, 2015

(54) TRICYCLE WITH REAR FACING BACK SEAT AND FOOT REST

(71) Applicant: JACK H. ASHKENAZIE, New York, NY (US)

(72) Inventor: JACK H. ASHKENAZIE, New York, NY (US)

(21) Appl. No.: 14/244,457

(22) Filed: Apr. 3, 2014

(51) Int. Cl. B62K 5/02

(52) U.S. Cl. CPC B62K 5/02

(57) ABSTRACT

The present invention provides a tricycle having a rear facing back seat, including a tricycle frame having one front wheel, two rear wheels, handle bars, and a front seat for the driver. The tricycle further includes a rear facing back seat located between the two rear wheels, and the rear back seat has a horizontal seat section, a vertical back rest, and a foldable foot rest extending downwardly from the horizontal seat section. In addition, the horizontal seat section includes a horizontal support frame for support, and the vertical back rest includes a vertical support frame for support. The two rear wheels each have protective wheel covers for covering the wheel spokes to protect the passengers hands, and the wheel covers are formed of lightweight transparent plastic panels which are perforated with openings.

### FIELD OF THE INVENTION

The present invention relates to a tricycle having a rear facing back seat, and a foldable foot rest, with the rear wheel having protective wheel covers.

### BACKGROUND OF THE INVENTION

There is a need for tricycles for transporting children or the elderly, but typical tricycles do not have a back seat with the necessary safeguards and protection.

It is an object of the present invention to provide a need for a tricycle having a rear facing back seat, with protective wheel covers, a seat belt, and a foot rest for preventing the passengers feet from touching the street surface.

### SUMMARY OF THE INVENTION

The present invention provides a tricycle having a rear facing back seat, including a tricycle frame having one front wheel, two rear wheels, handle bars, and a front seat for the driver. The tricycle further includes a rear facing back seat located between the two rear wheels, and the rear back seat has a horizontal seat section, a vertical back rest, and a foldable foot rest extending downwardly from the horizontal seat section. In addition, the horizontal seat section includes a horizontal support frame for support, and the vertical back rest includes a vertical support frame for support. The two rear wheels each have protective wheel covers for covering the wheel spokes to protect the passengers hands, and the wheel covers are formed of lightweight transparent plastic panels which are perforated with openings.

### BRIEF DESCRIPTION OF THE DRAWINGS

FIG. 1 is a side perspective view of the tricycle frame having a rear facing back seat;

FIG. 2 is a side perspective view of the entire tricycle frame having a rear facing back seat;

FIG. 3 is a side perspective view of the entire tricycle frame showing the mesh-like support frame for the back seat, with the back seat separated from the support frame;

FIG. 4 is another side view of the tricycle frame and an alternative structure for the rear facing back seat;

FIG. 5 is a rear view of the tricycle frame and the rear facing back seat, with the foot rest in its extended position;

FIG. 6 is a rear view of the tricycle frame and the rear facing back seat, with the foot rest in its folded position;

FIGS. 7a, 7b, and 7c show different views and positions of the foot rest design;

FIG. 8 shows a person in a dotted line view sitting in the back seat with their feet in the foot rest; and also shows the protective wheel covers; and

FIG. 9 is a exploded perspective view of a rear wheel showing the inner and outer protective wheel covers, which are perforated with openings.

### DETAILED DESCRIPTION OF THE PREFERRED EMBODIMENT

The present invention provides a tricycle 10 having a rear facing back seat 30, including a tricycle frame 12 having one front wheel 14, two rear wheels 16 and 18, handle bars 20, and a front seat 22 for the driver. The tricycle 10 further includes a rear facing back seat 30 located between the two rear wheels 16 and 18, and the rear back seat 30 has a horizontal seat section 32, a vertical back rest 36, and a foldable foot rest 40 extending downwardly from the horizontal seat section 32. In addition, the horizontal seat section 32 includes a horizontal support frame 34 for support, and the vertical back rest 36 includes a vertical support frame 38 for support. The two rear wheels 16 and 18 each have protective wheel covers 50 and 60 for covering the wheel spokes 52 and 62 on each wheel to protect the passengers hands, and the wheel covers 50 and 60 are formed of lightweight transparent plastic panels 54 and 56 for the left rear wheel, and wheel covers 64 and 66 for the right rear wheel. Each of said protective panels 54, 56, 64, and 66 are formed of lightweight transparent plastic panels, which are perforated with openings.

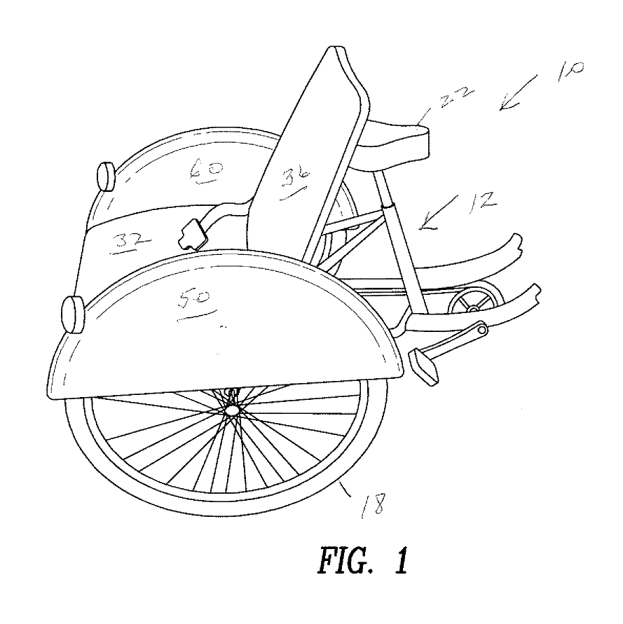

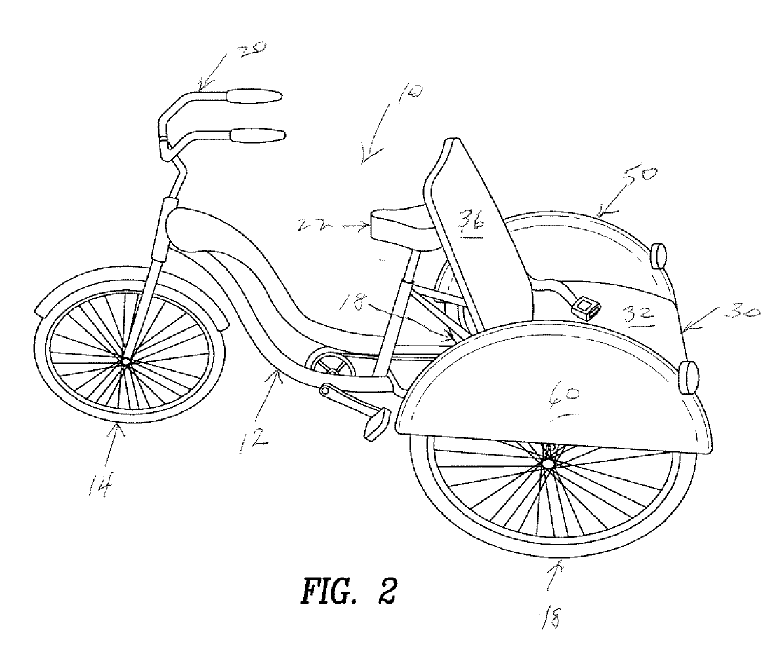

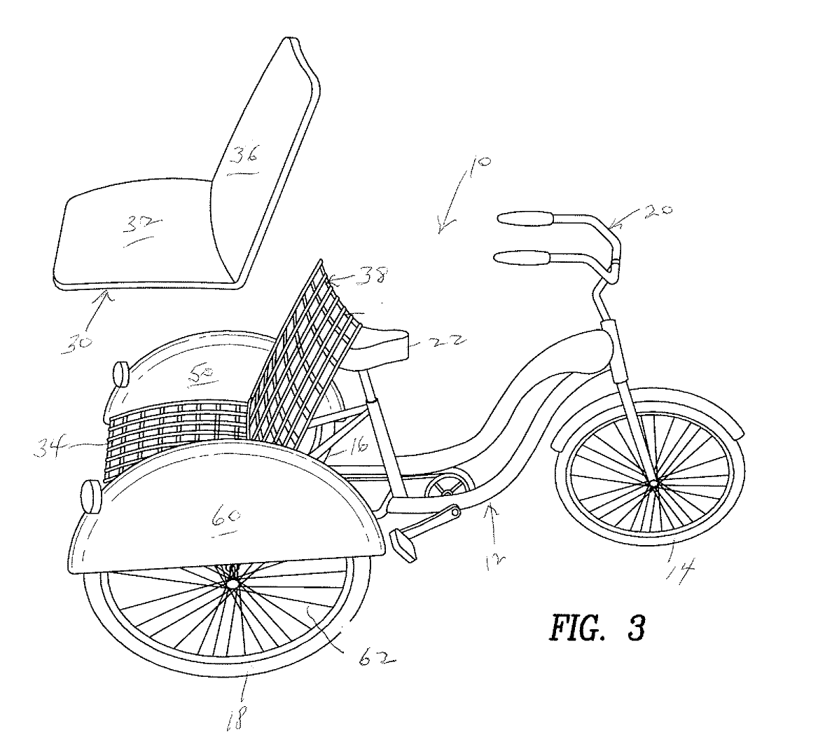

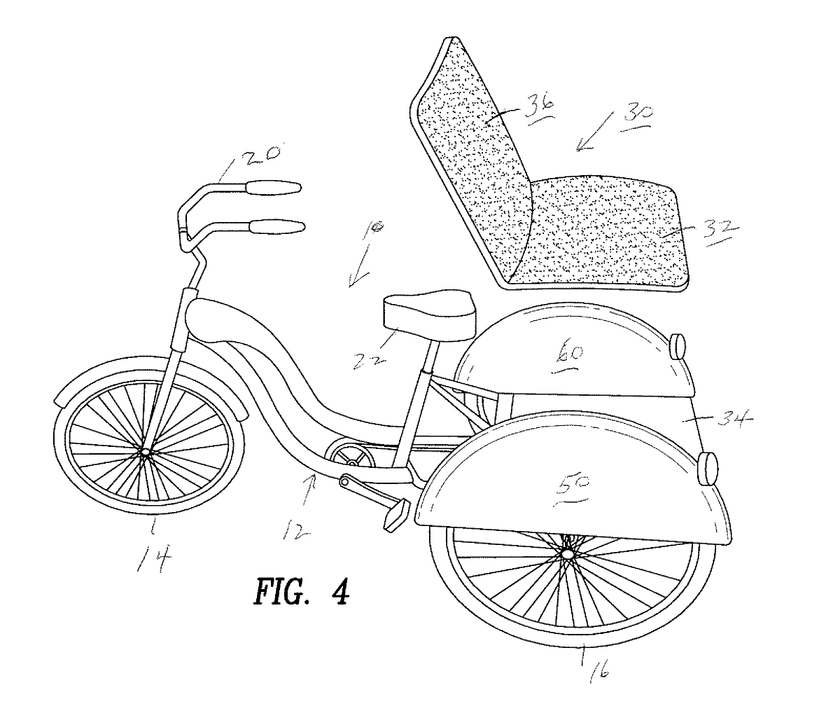

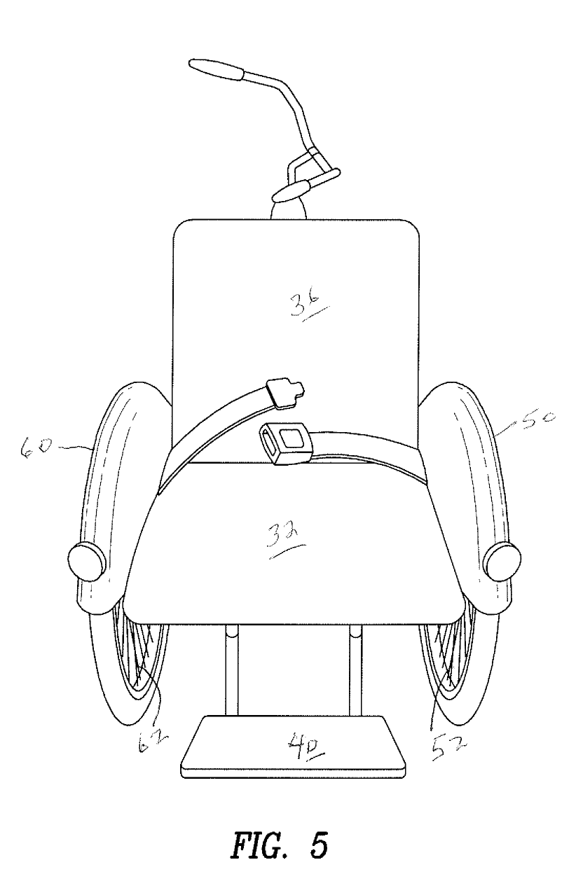

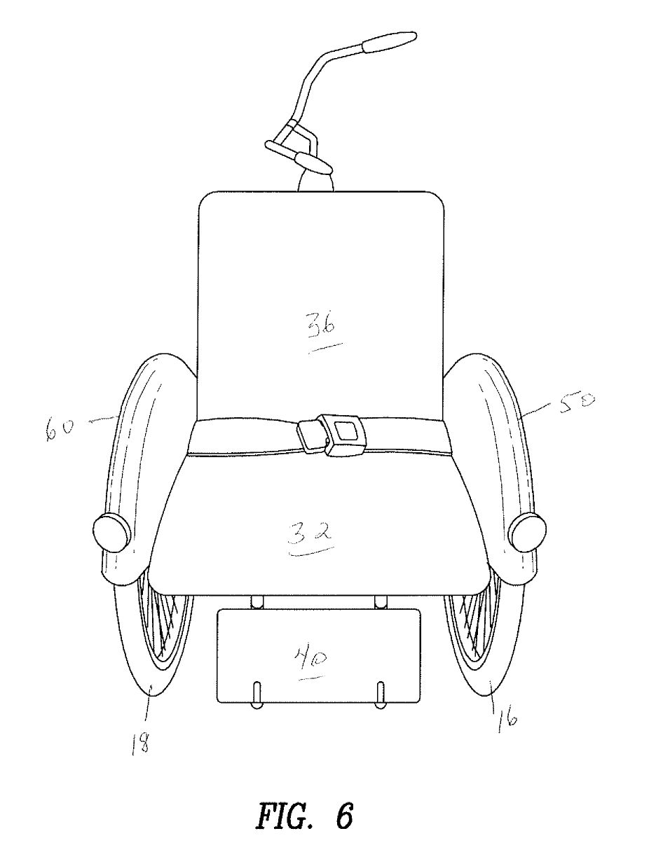

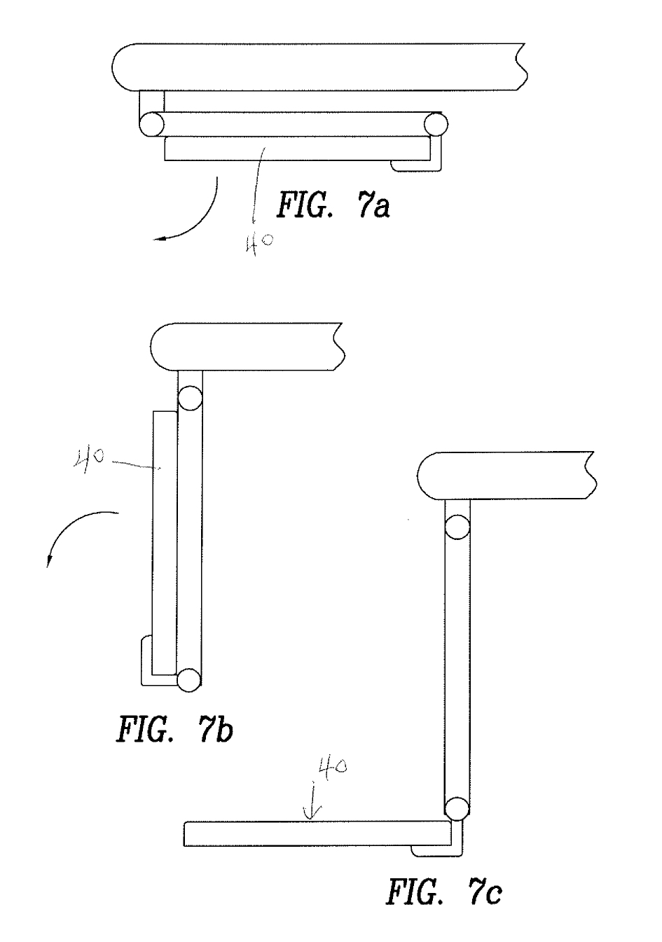

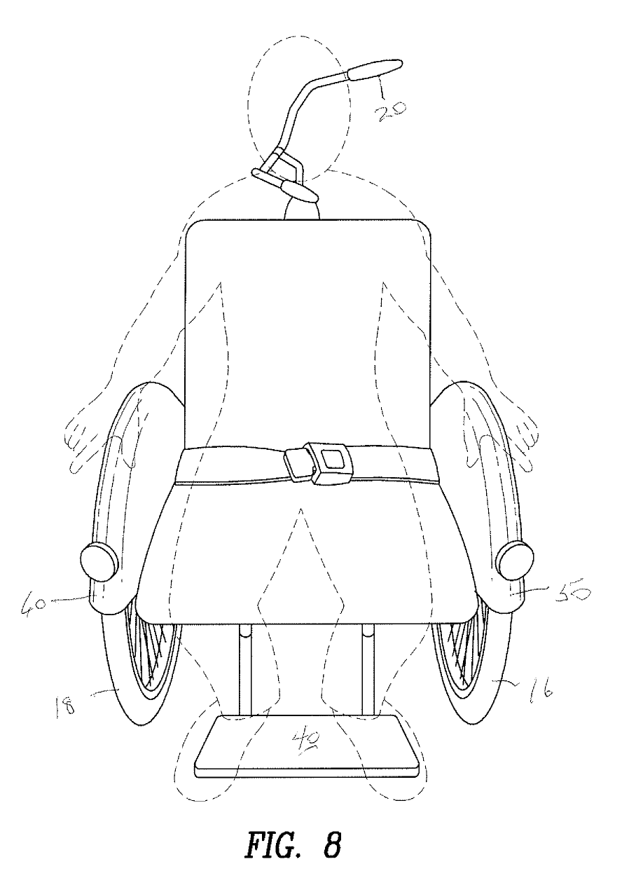

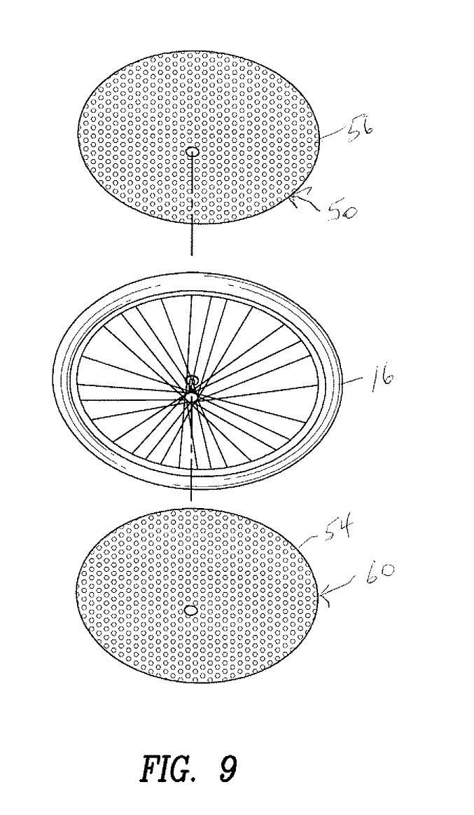

FIG. 1 shows a side perspective view of the tricycle frame 10 having a rear facing back seat 30. FIG. 2 shows a side perspective view of the entire tricycle frame 10 having a rear facing back seat 30. FIG. 3 shows a side perspective view of the entire tricycle frame showing the mesh-like support frame 38 for the back seat 30, with the back seat 30 separated from the support frame 38. FIG. 4 shows another side view of the tricycle frame 10 and an alternative structure for the rear facing back seat 30. FIG. 5 shows a rear view of the tricycle frame 10 and the rear facing back seat 30, with the foot rest 40 in its extended position. FIG. 6 shows a rear view of the tricycle frame 10 and the rear facing back seat 30, with the foot rest 40 in its folded position. FIGS. 7a, 7b, and 7c show different views and positions of the foot rest design 40. FIG. 8 shows a person in a dotted line view sitting in the back seat 30 with their feet in the foot rest 40; and also shows the protective wheel covers 50 and 60. FIG. 9 is a exploded perspective view of a rear wheel showing the inner and outer protective panels 54 and 56, which are perforated with openings.

### OPERATION OF THE PRESENT INVENTION

The passenger is placed in the rear seat and the seat belt is fastened. In addition, the foot rest 40 is folded downwardly and the passenger's feet are placed on the foot rest for safety.

### ADVANTAGES OF THE PRESENT INVENTION

The present invention has provided the advantage of a tricycle having a rear facing back seat, with protective wheel covers, a seat belt, and a safety foot rest for preventing the passengers feet from touching the street surface.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A tricycle having a rear facing back seat, comprising:
a) a tricycle frame having one front wheel, two rear wheels, handle bars, and a front seat for the driver;
b) a rear facing back seat located between the two rear wheels, said rear back seat having a horizontal seat section, a vertical back rest, and a foldable foot rest extending downwardly from the horizontal seat section; and
c) said two rear wheels each having protective wheel covers for covering the wheel spokes to protect the passengers hands.

2. A tricycle in accordance with claim 1, wherein said horizontal seat section includes a horizontal support frame for support, and said vertical back rest includes a vertical support frame for support.

3. A tricycle in accordance with claim 1, wherein said protective wheel covers are formed of lightweight transparent plastic panels which are perforated with openings.
